(19) United States
(12) Patent Application Publication
(10) Pub. No.: US 2007/0031110 A1
(43) Pub. Date: Feb. 8, 2007

(54) Method of recording and of replaying and video recording and replay systems

(75) Inventor: Albert Maria Arnold Rijckaert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/556,248

(22) PCT Filed: May 12, 2004
(86) PCT No.: PCT/IB04/50646

§ 371 Date: Nov. 10, 2005

(30) Foreign Application Priority Data
May 16, 2003 (EP) 03101371.7

(51) Int. Cl. H04N 5/91

(52) U.S. Cl. 386/68

(57) ABSTRACT

A video stream and different trickplay versions of that stream are stored as separate files in a randomly accessible storage medium. In order to facilitate seamless switching between streams linking information is provided, which links positions of content within the normal play stream to positions of corresponding content within the trickplay streams. Upon receiving a switch command for switching between trickplay modes or to or from a normal play mode the linking information is consulted to determine corresponding locations in different streams for the different modes and used to jump to a point within the new stream.

The invention is related to recording and replaying video information from randomly accessible storage devices, such as discs. In particular, the invention is related to configurations in which more than one process concurrently has access to a randomly accessible disc, e.g. via time slot multiplexing. Such configurations may be present in situations where video on demand services are offered. In this case a video replay system outputs several concurrent video streams, which are all read from the disc. In some situations the same video is even replayed for different users, which started the video at different times.

It is desired to extend the options of the above described video replay system to permit the individual user to switch between different replay modes, as in home video recorders. In normal play mode a video is replayed at a rate, which is in accordance with an original recording speed. In a trickplay mode the video is replayed at another rate, e.g. fast forward or in reverse.

In home video recorders trickplay modes like fast forward and reverse are implemented by spooling the magnetic tape in the desired direction and with the desired speed along the magnetic head and by reading video frames at preselected instants from the tape. Video frames that are used during normal replay are also used for trickplay, but dedicated video frames for trickplay may be provided as well, near the positions on the tape where corresponding normal play frames are recorded. If a user gives a command to switch to another replay mode during spooling, the direction and the speed of the magnetic tape are adjusted. The video recorder continues to replay the video in the newly selected mode. Thus it is possible to switch between different replay modes at arbitrary instants in response to user commands.

From U.S. Pat. No. 6,453,115 a video replay system is known that employs randomly accessible memory to store a stream and uses tables with pointers referring to so-called I-frames in the video stream in order to support trick play. I-frames represent a part of the video information in MPEG coded video data. Trickplay streams are generated by jumping to selected I-frames and by reading them in arbitrary order. However, jumping to different disc locations for retrieving the selected I-frames places a severe demand on the access bandwidth of the disc, so that the number of processes that may read the disc is relatively small. This is in particular the situation if all these processes run in a trickplay mode, such as fast forward or fast reverse.

It is an object of the invention to enable switching between different replay modes at arbitrary instants during replay of a video stream while reducing the amount of access bandwidth of the randomly accessible memory that is required for access. Therefore a method of recording a video stream according to the invention comprises the steps of receiving a video stream; generating from the video stream a normal play stream and a trickplay stream representing the normal play stream at a trickplay rate by selecting and arranging data from the normal play stream; storing normal play stream data and trickplay stream data as separately accessible files on at least one randomly accessible storage device; and providing linking information, which links the selected data from the normal play stream in the trickplay stream with corresponding data in the normal play stream.

By storing a normal play stream and a trickplay stream as separately accessible files, which can each by itself be played in the same way as a normal stream, memory access optimization strategies may be applied to video streams for different trick play modes individually, such as storing successive parts of a file in successive tracks and sectors. Methods of storing separate files and file storage optimization strategies are well known per se, for example for computer (PC) hard disks. Such strategies make it possible to reduce the access bandwidth demand to access the randomly accessible storage device. By providing separate files for different play modes including a normal play mode and one or more trickplay modes, trickplay will not lead to a higher bandwidth use. As a result, more users can be connected to the video replay system, or more access bandwidth requiring operations can be performed on the at least one randomly accessible storage device. By providing linking information which links trickplay stream data with normal play stream data, the system is enabled to switch virtually seamlessly from the normal play mode to the trickplay mode, and vice versa. Storing the normal play stream and the trickplay stream as separately accessible files is also advantageous when the trickplay stream is generated and stored in semi real time from the normal play stream, i.e. when the generation of the trickplay stream takes place in a non-instantaneous way while the normal play stream is recorded.

The invention is also related to a method of replaying a video stream which comprises the steps of providing a randomly accessible memory on which normal play stream data and trickplay stream data are stored as separately accessible files, the trickplay stream data representing the normal play stream data at a trickplay rate, being selected and arranged from the normal play stream, providing linking information, which links the selected data from the normal play stream in the trickplay stream with corresponding data in the normal play stream; retrieving one of a plurality of play stream data from the at least one randomly accessible storage device; generating part of a video stream from the retrieved play stream data; receiving a switch signal during replay of the generated part of the video stream, the switch signal representing a new play mode; reading the linking information; determining by means of the linking information a first position in the play stream according to the new play mode, the position corresponding to a second position in the part of the video stream that is displayed at the moment on which the switch signal is received; retrieving new play stream data from the at least one randomly accessible storage device according to the new play mode, starting with data related to the determined first position; and generating a new video stream from the retrieved new play stream data.

During replay a controller, which is provided on a video replay system, retrieves a play stream and generates a video stream according to a received signal representing a play mode. As an example, if an individual user selects a normal play mode, the controller generates a video stream by retrieving normal play stream data from a first file. If a user wants to switch to another, new replay mode at an arbitrary instant during replay of the video, he or she generates a signal representing the new play mode by communicating via an interface terminal. The controller receives this signal and retrieves new play stream data from a separate, second file, according to the new play mode. This is accomplished by starting with new data forming the new stream and corresponding to data at the position in the generated video stream according to the previously play mode where the switch occurred. Correspondence of these data is available, since linking information is provided during the record of the video stream. Again, as an example, if the user selects a trickplay mode during replay of the video, the controller retrieves trickplay stream data, starting from a position in the stream that corresponds to the present position in the normal play stream data. Due to the provided linking information which links corresponding image representation data, the controller is able to perform this operation. Then, the controller generates a new video stream from the retrieved new play stream data for replay at a replay terminal.

Thus the invention enables a video system offering video on demand services, to replay several videos for different users, and to switch each video stream from normal play mode to a trickplay mode and vice versa upon request of an individual user.

Other embodiments according to the invention are expressed in the dependent claims.

The objects and the advantages of the invention will be illustrated using exemplary embodiments shown in the drawing. In the drawing shows:

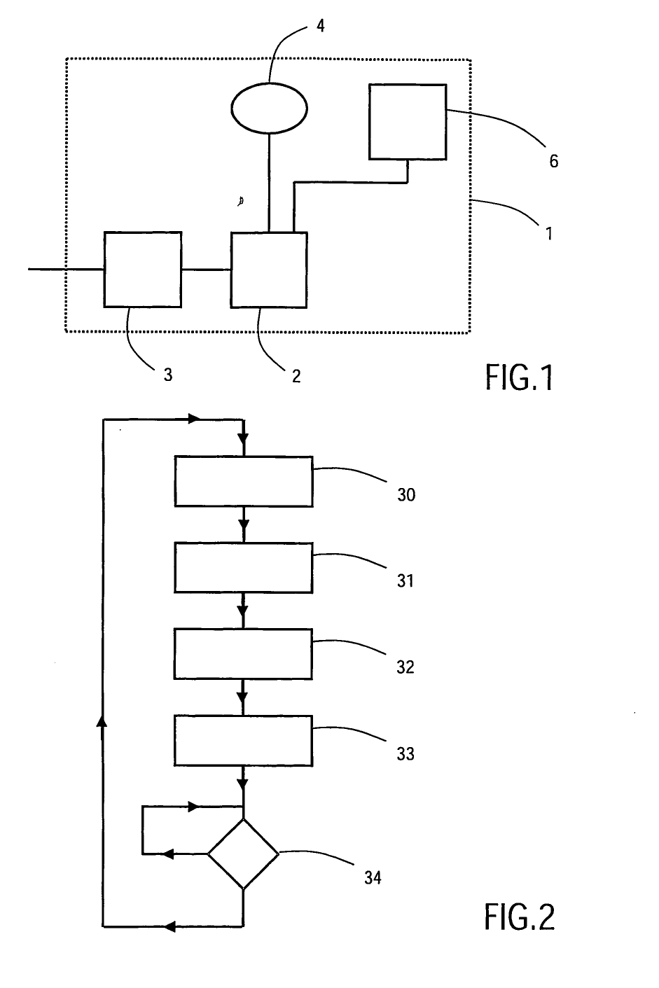

FIG. 1 a video recording system according to the invention;

FIG. 2 a flowchart representing a method of recording a video stream;

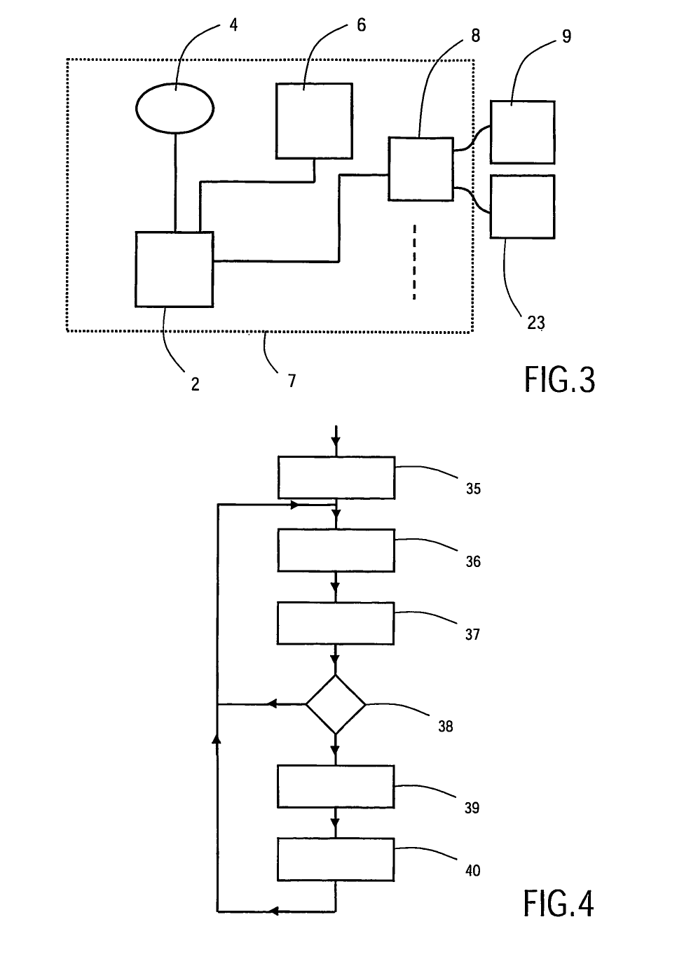

FIG. 3 a video replay system according to the invention;

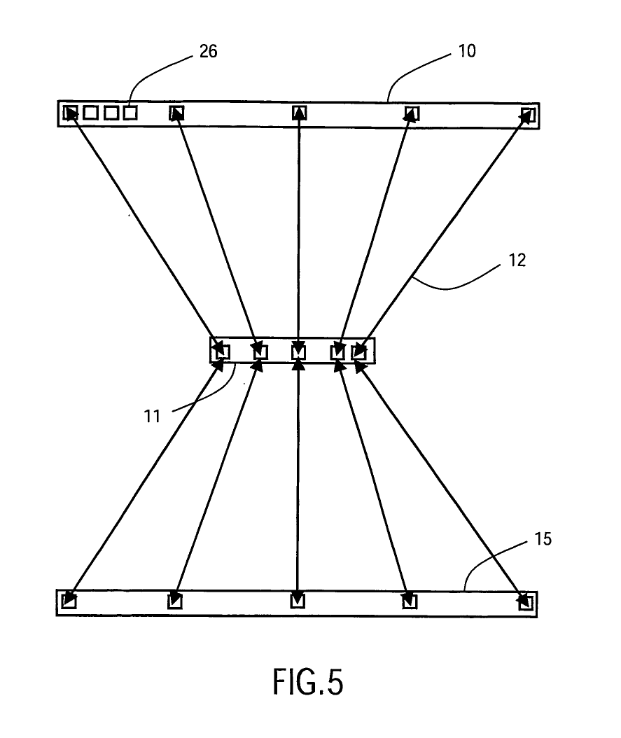

FIG. 4 a flowchart representing a method of replaying a video stream;

FIG. 5 a scheme of video stream data according to the invention;

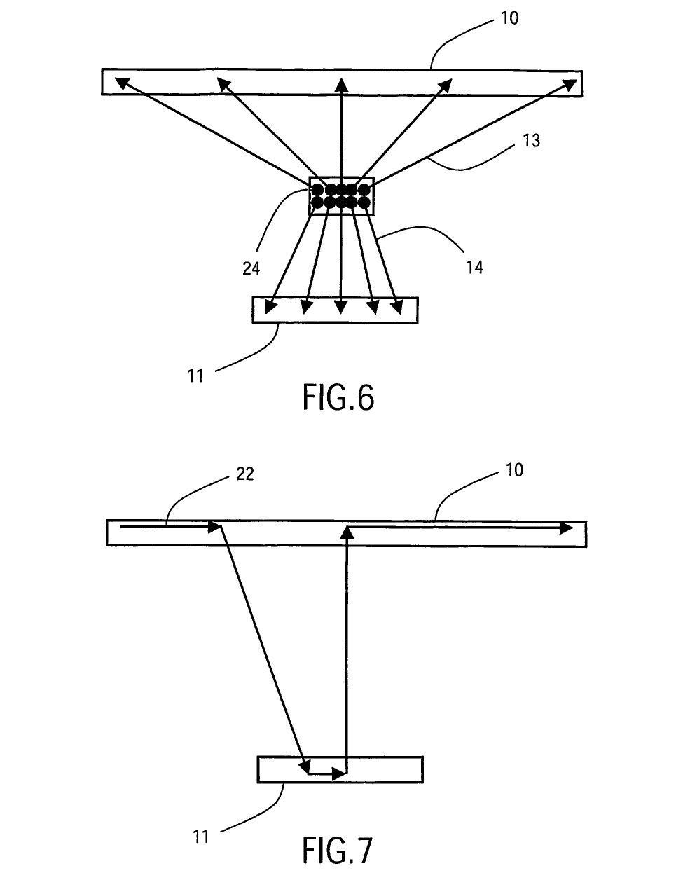

FIG. 6 a scheme according to FIG. 5 showing a table with pointers;

FIG. 7 a scheme of replaying a video using different play modes according to the invention; and

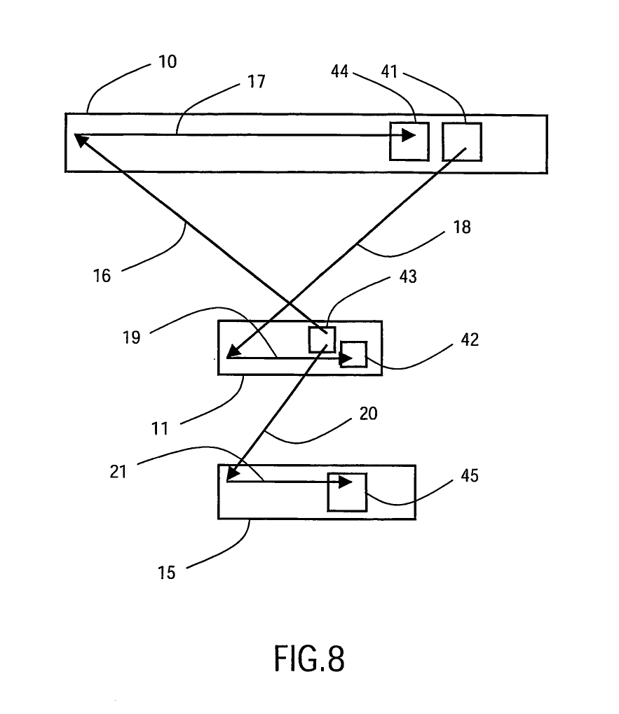

FIG. 8 a scheme according to FIG. 5 showing pointers in the video stream data.

In FIG. 1 a video recording system 1 is shown. The system 1 comprises a controller 2, which is connected to an input terminal 3, and a randomly accessible storage device 4, such as a disc. The disc 4 may comprise a magnetic disc, CD, or DVD. The controller 2 is also connected to a further memory device 6 comprising a table with linking information.

A flow chart of the recording process is shown in FIG. 2. In use, as a first step 30 the video recording system 1 receives the video stream data via the input terminal 3. In one embodiment the video stream is encoded, e.g. by means of an MPEG coding algorithm in order to save memory space, or even encrypted to prevent unauthorized access. In a second step 31 controller 2 generates a trickplay stream data from the received video stream. In a third step of the recording method, the controller 2 controls a storage process of data on the disc 4. More particularly at least two kinds of video stream data are stored as separately accessible file on the at least one disc 4, viz. as a file for normal play stream data and another file for trickplay stream data.

The normal play stream data represent the video data for replaying in a normal play mode, at a realistic rate, i.e. a rate that is in accordance with an original recording rate. The normal stream may be a copy of the received video data, or may be newly generated (for example compressed and/or encrypted) by controller 2. The trickplay stream data generated by controller 2 represent the same video data as normal play stream data, but so that upon normal replay of this trickplay stream a trickplay effect occurs as compared with the normal stream, such as fast forward or fast reverse. Controller 2 generates trickplay stream data by selecting and arranging data from the normal play stream. In this way information from the normal play stream is extracted to form the trickplay stream. Preferably controller 2 compresses and/or encrypts the trickplay stream data before storage.

During the storing process, as a fourth step 33, the controller 2 writes linking data in a table that is stored in the further memory device 6. The table comprises linking information with respect to the video stream as will be explained below. Although a separate further memory device is shown, it will be appreciated that the table may also be stored on the same disc 4 as the streams (optionally as a table part, or distributed table parts in one or more of the streams), or that copies may be stored at multiple locations. In the fifth step 34, the processor checks if more video data is to be recorded. In that case the process continues with the first step 30. Otherwise, the controller awaits for the next video information.

In FIG. 3 a video replay system 7 is shown. The replay system 7 comprises partly the same elements as the video recording system 1. The controller 2 provided on the replay system 7 is connected to the disc 4 and to the further memory device 6. The controller 2 is further connected to a set of output terminals 8, which are all connectable to both a replay terminal 9 and an interface terminal 23. Each output terminal 8 interacts with an individual user via the replay terminal 9 and the interface terminal 23. Hence, the video replay system 7 is dedicated for video on demand (VOD) services for multiple users.

FIG. 4 schematically shows a flow chart of the method of replaying video streams by means of the video replay system 7. In a first step 35, a user selects a program, e.g. a film. The user communicates with the controller 2 via the interface terminal 23 and the output terminal 8. Upon selection of the program replay system 7 automatically selects a current play mode, preferably the normal play mode, for replaying the selected program. If desired, the user may command selection of another current play mode, e.g. trickplay mode at this time.

As a second step 36, the controller 2 retrieves from the disc 4 one or more frames from the video file that corresponds to the selected program in the current play mode. When the current play mode is the normal play mode, for example, frames from the file for normal play stream data are retrieved. In a third step 37 the controller generates a segment of a video stream from the retrieved frames for replay on the replay terminal 9 of the user. In the fourth step 38 the user is enabled to select another play mode. If no selection is carried out, the replay process is continued from the same file returning to the second step 36.

If the controller 2 receives a switch signal representing a selection by the user of a new play mode via the above described communication chain 8, 23, the video replay system 7 will change the current play mode to the newly selected replay mode and start replaying the selected program in the new replay mode, e.g. a trickplay mode. Replay system 7 accomplishes this by retrieving frames for the new play stream data from another file, selected according to the new play mode in second step 36 and generating a new, second video stream from the retrieved new play stream data in third step 37, and outputting the new video stream to the output terminal 8.

In step 39, prior to executing from second step 36 for the newly selected replay mode, controller 2 reads the linking information that has been provided during the storing process described with reference to FIG. 2. The linking information may be read from disc 4 (optionally as a table from one of the streams, or as successive instalments of the table from an ongoing stream, or from a memory into which the linking information may be copied from disc 4, initially when play of the stream is started, or into which the linking information has been written during recording. In step 40, the controller 2 determines the position in the play stream data file for the newly selected play mode, which corresponds to the position in the play stream data file to which display had advanced during replay in the previous play mode.

After the controller 2 has determined the position in the play stream data file for the new play mode the process continues with the second step 36 and 37, i.e. retrieving video data from the newly selected video file, and generating a new video stream starting from the position that has been determined. Thus the controller 2 jumps from a first selected file to a new, second selected file, at a position that contains content that corresponds to the content in the original file, following the position to which display had advanced at the time of the switch.

FIG. 5 illustrates linking information. FIG. 5 schematically shows the normal replay stream 10 and two trickplay streams 11, 15. For particular positions in video streams the table comprises address information concerning data in the play streams that correspond to the particular positions. In a particular embodiment according to the invention the table may be represented as in table I

TABLE I
Linking information

| | position 1 | position 2 | position 3 |
|---|---|---|---|
| stream 1 | address 1 | address1a | address1b |
| stream 2 | address 2 | address2a | . . . |
| stream 3 | address 3 | . . . | . . . |
| . . . | . . . | . . . | . . . |

Hence, during the recording stage, address information of corresponding data in at least the normal play stream and at least one trickplay stream is stored in the table 24 as is indicated in FIG. 6 with respect to the normal play stream 10 and one trickplay stream 11 for particular positions in a particular video stream. The address information, which is also called linking information, may also concern data from a second trickplay stream or from even more trickplay streams. The address information specifies addresses in the files for different play modes that contain corresponding content from the stream. By means of the linking information, the controller 2 is enabled to interconnect data in different video play streams of one particular video. In other words, corresponding data in different play streams 10,11 are interconnected by means of linking information 12 which is stored in the table during the recording process.

In particular, the address information contained in the table may point to memory locations in the files where sections of streams have been stored that represent the same frame or frames, e.g. an I-frame or groups of pictures (GOPs) in MPEG coded video which are represented as file packet numbers. The use of addresses of I-frames has the advantage that the image can immediately be replayed without retrieving data from other frames. In essence, the linking information of the table 24 comprise pointers 13, 14 referring to the sections.

Instead of pointing directly to memory corresponding locations in files, the linking information may also contain information that is sufficient to compute corresponding locations. A location of content x may be computed for example using a formula L(x)=L0+R*x in case of a fixed compression rate stream. R, the replay rate is known for each stream. When L0 values are provided for each stream corresponding locations can be computed. Preferably, a plurality of L0 values is provided each for a respective section in the stream to permit more accurate computations. This works well for streams that use fixed rate compression (for example for part of the streams) but not for streams that use variable rate compression. In the latter case more L0 values may be provided for different sections of the stream, together with local R values. Even if this does not provide accurate locations, it may be used to speed the search for the correct location, using PCR values for example. A similar technique may be used to compute corresponding PCR values in different streams.

The linking information may be stored as a separate table, or as a table part of one or more of the streams. The table for the whole stream need not be provided as a single table, but instead successive instalments of the table may be included in the stream, each for switching to another mode during a subsequent part of the stream. From the MPEG standard, for example, several techniques for including tables in a stream for other purposes are known, similar techniques may be used for including tables for switching between trickplay modes and a normal mode. In this case, instalments of the table are preferably loaded into a working memory each time when they are encountered.

If the video replay system 7 switches from a first play mode to a second play mode, the controller 2 searches in the table 24 for a position in the first play stream, also called reference point, which is close to a section 26 of the first play stream that represents an image which is replayed just before switching the play mode.

There are several ways of finding such a reference point in the first play stream. In one embodiment the controller 2 selects the reference point in the table 24, which corresponds to the address of the most recently replayed section 26 in the video stream before the switch. In another embodiment the controller 2 selects the reference point in the table 24 corresponding to the address of the section 26 next to the switch. In yet another embodiment the controller 2 selects the reference point in the table 24 which corresponds to the address of the section 26 which is chronologically most near the moment in the video stream at which the switch occurs. When the reference point in the table 24 has been selected, the pointer 13,14 relating to the play stream data 10, 11, 15 according to the second play mode, provides address information for finding the desired section 26 in the stream that represents an image, which needs to be retrieved in order to continue the process of generating the video stream 37. In this way the controller 2 switches from a first replay mode to a second replay mode and vice versa.

FIG. 7 shows again the normal replay stream 10 and one trickplay stream 11. Further a switching path 22 is schematically shown, starting with video data in the normal replay stream data 10. In this situation the user has selected a first, normal replay mode. At a particular moment the controller 2 retrieves video data from the trickplay stream data 11 as a response to the user which selects a second, trickplay mode. After some time the user selects the normal mode again, and the controller continues to generate a new video stream by retrieving video information from the normal playstream data 10. Each time a nearly seamless switch is performed through the use of linking information.

In other embodiments of the invention the linking information is implemented in the video streams and not in a separate table. One embodiment makes use of MPEG PCR information to realize linking. In MPEG coded video streams, program clock references (PCRs) synchronize the replay rate with respect to the recording rate. The normal play stream and the trickplay stream have different PCR time bases, due to the different replay rate or time direction of the video play mode.

In an embodiment the linking information is stored in the form of information about PCR values of positions with corresponding content in the normal stream and the trick play stream or streams. The information about such corresponding PCR values may be stored in the files for each stream, or only in a subset of the files, for example only in the file that contains the stream for normal play. Such linking information may be provided in the form of sets of corresponding PCR values stored at various positions in a video stream for a particular play mode, the PCR values in each set specifying the PCR values of corresponding content in video streams for the same program in different play modes. The corresponding PCR value in the stream in which the set is stored may be part of the set, or may be implied by the PCR value that corresponds to the position in the stream where the set is stored in the stream. The embodiment in which the file for the stream for each play mode contains information about corresponding PCR values in the streams for other play modes will be illustrated first.

During a switch from the trickplay mode to the normal play mode, while a section 43 of the trickplay stream 11 is replayed, the controller 2 determines a reference point near the section 43 according to a search algorithm, e.g. as described above. Next, the controller 2 determines the PCR time value of the reference point in the normal play stream 10, from information about the corresponding PCR value stored in the trickplay stream. Then the controller 2 searches in the normal play stream 10 until the corresponding PCR time value has been found. The search activities are symbolically illustrated in FIG. 8 by means of arrows 16, 17. Although a chronological search from the start of the stream is used, it should be understood that other types of search may be used, for example a binary search (reading a PCR from midway the file, determining whether it is above or below the required PCR, reading a PCR from midway the section in front of or behind the midway position, dependent on whether the required PCR is lower or higher respectively and so on) or an indexed search (using a table of locations in the stream for a number of PCR values, finding a location of a PCR nearest the required PCR values and searching the stream from there). When the PCR time base in the normal play stream has been found, the controller 2 starts retrieving normal play stream data at a section 44 corresponding to PCR value, to generate a new video stream for replay. The switch from the trickplay mode to the normal play mode has been performed.

An advantage of providing linking information in the video stream rather than in a separate table is that the linking information in the video stream is more dynamic and invariant for the sequence of a decoding and a new encoding step.

A switch from the normal play mode to a trickplay mode is performed in a similar way. When a user commands for a switch during replay of a section 41 in the normal play stream, the controller 2 determines a reference point near the section 41, finds the corresponding PCR value in the trick play stream from linking information in the normal stream and searches in the trickplay stream for the PCR value, and starts retrieving trickplay stream data at a section 42 corresponding to the reference point. The search activities of the controller 2 are symbolically illustrated by means of arrows 18 and 19.

A switch from a first trickplay mode to a second trickplay mode is performed along the same lines as a switch from a trickplay mode to the normal play mode, provided that the controller 2 searches in the second trickplay stream data for the stored PCR time base in the normal play stream 10 to find the corresponding section 45 in the second trickplay stream data. The search activities of the controller 2 are symbolically illustrated by means of arrows 20 and 21.

In another embodiment, linking information that specifies corresponding PCR values of different streams may be stored in a selected streams only, for example in the normal play stream. In this case a switch to the new play stream from another stream at a specific PCR value in that other stream involves a search in the normal play stream for a location where the specific PCR value for the other stream is stored, retrieval of the corresponding PCR value for the new stream (this may implicit in the location where the specific PCR value is stored if the switch is to the normal stream) and replay from the new stream, starting from the new PCR value. When the linking information about corresponding PCR values is stored in a trick play stream only a similar procedure hold mutatis mutandis. The use of a fast play stream for this purpose may be advantageous in this case if the speed of the search for the corresponding PCR value is important.

The above described embodiments are particularly suited for applications using MPEG coded video streams. The embodiments permit constant bit rate (CBR) as well as variable bit rate (VBR) coding schemes.

In yet another embodiment according to the invention it is assumed that CBR encoding schemes have been applied to the video streams. The linking information that is stored during the record stage contains the total length of each of the normal play stream and of one or more trickplay streams. During a switch from a normal play mode to a trickplay mode the controller 2 computes from the relative position in the normal play stream, the relative position in the trickplay stream, using the linking information, e.g. as a fraction of the total length. Then the controller 2 continues with retrieving data and generating the new play stream. Switching from a trickplay mode to the normal play mode or to another trickplay mode occurs also by means of computing relative positions in the play streams.

In another embodiment the controller 2 computes a relative time position in a normal play stream using the total time period of the stream which has been stored during a recording process as linking information, and the current PCR time base corresponding with a section which is currently replayed. For performing a switch from the normal play mode to a trickplay mode, the controller 2 determines from the relative time positions a relative file position in the trickplay stream, assuming the trickplay stream is coded with CBR schemes. This method is suited for application when the normal play stream is coded using VBR algorithms.

In yet another embodiment the controller 2 computes a relative file position in a trickplay stream from which new video data is to be retrieved, by using the total time period of the normal play stream being currently replayed, the total time period of the trickplay stream, and the current PCR time base corresponding with a section which is currently replayed. If a stored normal play stream PCR time base in the determined relative file position in the new play stream does not match with the section in the normal play stream, the controller 2 preferably performs a new iteration step, e.g. by linearization using the packet numbers in the normal play stream and trickplay stream, respectively, and the stored normal play stream PCR time base in the trickplay stream.

The invention is not restricted to the described embodiments. Many alternative video systems replaying video streams by means of linking information are possible.

It is noted that the sections of streams that represent images do not necessary contain GOPs or I-frames. Also P-frames or B-frames are possible.

Further, the invention is not restricted to one disc 4. The video recording system and/or the video replay system may comprise two or more discs on which normal play stream data files and trickplay stream data files are stored. In a preferred embodiment, normal play stream data and trickplay stream data are stored on different discs in order to reduce access bandwidth of the discs and/or reduce the switching time. Thus activities relating to both the normal play stream and the trickplay stream can be executed more or less simultaneously.

In another embodiment the video streams (the normal stream and the trickplay streams) may be recorded in encrypted form or encrypted during replay, to prevent illegal use of video data. In this case, the linking information is preferably provided so that it can be accessed without decrypting the stream. This makes it possible to switch quickly between encrypted streams for normal and trick mode replay. The controller generates a trickplay stream from the normal play stream which is either compressed or uncompressed.

Further, it is advantageous to construct trickplay streams using I-frames or GOPs from the normal play stream, since the replay of I-frames and GOPs do not need information of other frames in the stream. This is in particular the case if the normal play stream is compressed. The above-mentioned approach saves decompression time for the controller.

In an embodiment according to the invention a reverse trickplay stream is generated. This is accomplished by generating the reverse trickplay stream from a forward trickplay stream. In a preferred embodiment the reverse trickplay stream is generated off-line when the entire normal play stream has been stored on disc. This approach saves bandwidth of the storage device and adjustments of timing information in the stream. When the reverse trickplay stream is generated, linking information is also generated and stored, for use during replay.

These embodiments are assumed to be obvious for the man skilled in the art and are considered to fall within the scope of the following claims.

1. A method of recording a video stream, comprising the steps of
receiving a video stream (10);
generating a trickplay stream (11, 15) from the video stream, by selecting and arranging data from the video stream (10), the trick play stream (11, 15), when played at normal rate, representing the video stream at a trickplay rate;
storing the trickplay stream (11, 15) and a normal play stream (10) corresponding to the video stream (10) as separately accessible files on at least one randomly accessible storage device (4); and
providing linking information (12), which links positions of content within the normal play stream (10) to positions of corresponding content within the trickplay stream (11, 15).

2. A method of replaying a video stream, comprising the steps of
providing a randomly accessible storage device (4) in which a normal play stream (10) and a trickplay stream (11, 15) are stored as separately accessible files, the trickplay stream (11, 15) when played at normal rate representing the normal play stream (10) data at a trickplay rate;
providing linking information (12), which links positions of content within the file for the normal play stream (10) to positions of corresponding content in the file for the trickplay stream (11, 15);
replaying a part of a play stream (10, 11, 15) from one of the files in the at least one randomly accessible storage device (4);
receiving a switch signal during replay of the part of the play stream (10, 11, 15), the switch signal for selecting a new play mode;
reading the linking information (12);
determining a first position in the file for the new play mode, the first position corresponding, according to the linking information (12), to a second position in the part of the play stream (10, 11, 15) that is replayed substantially at the time on which the switch signal is received;
continuing replay with new play stream data from the file corresponding to the new play mode, starting with data determined by the first position.

3. A method of replaying according to claim 2, wherein the normal stream and the trick play stream contain program clock references (PCR) for defining progress of time during play of the normal stream (10) and the trick play stream (11, 15) defined to respective tine bases respectively, wherein the linking information specifies correspondence information items, each between program clock reference (PCR) values of corresponding positions in the respective streams (10, 11, 15), the method comprising retrieving a program clock reference (PCR) value for the first position from the linking information, and searching for the first position on the basis of the retrieved program clock reference value.

4. A method of replaying according to claim 3, wherein the linking information is contained in and retrieved from the file that contains the play stream (10, 11, 15).

5. A method of replaying according to claim 4 wherein the correspondence information items are stored in at least one of the files for the normal play stream (10) and the trick play stream (11, 15), each at a position substantially where the clock reference (PCR) value of the item assumes the value corresponding to the item.

6. A method of replaying a video stream according to claim 2, wherein the method further comprises the step of successively displaying video information decoded from the play stream (10, 11, 12) and the new play stream (10, 11, 12) on a display device.

7. A video recording system, comprising
an input terminal (3) for receiving a video stream;
at least one randomly accessible storage device (4);
a controller (2) arranged to
generate a normal play stream (10) and the trickplay stream (11, 15) from the received video stream, the trickplay stream (11, 15) by selecting and arranging frames from the received video stream, so that the trickplay stream (11, 15) represents, when played at a normal rate, the normal play stream (10) at a trickplay rate
store the normal play stream (10) and trickplay stream (11, 15), as separately accessible files in the randomly accessible storage device (4) and
generate linking information (12) which links positions of content within the normal play stream (10) to positions of corresponding content within the trickplay stream (11, 15).

8. A video recording system according to claim 7, wherein the normal stream (10) and the trick play stream (11, 15) contain program clock references (PCR) for defining progress of time during play of the normal stream (10) and the trick play stream (11, 15) defined to respective time bases respectively, the controller (2) being arranged to store linking information specifying correspondence information items, each between program clock reference values of corresponding positions in the respective streams.

9. A video recording system according to claim 7 wherein the correspondence information items are stored in at least one of the files for the normal play stream and the trick play stream, each at a position substantially where the clock reference value of the item assumes the value corresponding to the item.

10. A video replay system, comprising
at least one randomly accessible storage device (4) for storing a normal play stream (10) data and a trickplay stream (11, 15) in separately accessible files, the trickplay stream (11, 15), when played at normal rate, representing the normal play stream (10) at a trickplay rate;
a controller (2) arranged to
replay a part of a play stream (10, 11, 15) from one of the files in the at least one randomly accessible storage device (4);
receive a switch signal during replay of the part of the play stream (10, 11, 15), the switch signal for selecting a new play mode;
read the linking information which links positions of content within the normal play stream (10) to positions of corresponding content within the trickplay stream (11, 15);
determine a first position in the file for the new play mode, the first position corresponding, according to the linking information, to a second position in the part of the play stream that is replayed substantially at the time on which the switch signal is received;
continue replay with new play stream data from the file corresponding to the new play mode, starting with data determined by the first position.

11. A randomly accessible memory medium (4) comprising
separate files that contain data representing a normal play stream (10) and a trickplay stream (11, 15) respectively, the trickplay stream (11, 15), when played at a normal rate, representing the normal play stream (10) at a trickplay rate, and
linking information (12), which links positions of content within the normal play stream (10) to positions of corresponding content within the trickplay stream (11, 15).

12. A randomly accessible memory medium according to claim 11, wherein the linking information comprises successive instalments of for successive parts of the streams (10, 11, 15) as tables in the streams (10, 11, 15).

13. A video play stream signal comprising successive instalments of linking information (12), which links positions of content within a normal play stream (10) to positions of corresponding content within one or more different trickplay versions (11, 15) of the video play stream.
